(19) United States
(12) Patent Application Publication
(10) Pub. No.: US 2012/0036009 A1
(43) Pub. Date: Feb. 9, 2012

(54) METHOD FOR EFFICIENTLY ALLOCATING AN ADVERTISING BUDGET BETWEEN WEB ADVERTISING ENTITIES

(75) Inventors: Michael Aronowich, Haifa (IL); Amir Bar, Rehovot (IL); Nir Cohen, Rishon Le Zion (IL)

(73) Assignee: KENSHOO LTD., Tel Aviv (IL)

(21) Appl. No.: 13/198,357

(22) Filed: Aug. 4, 2011

Related U.S. Application Data
(60) Provisional application No. 61/371,701, filed on Aug. 8, 2010.

(51) Int. Cl. G06Q 30/00

(52) U.S. Cl. 705/14.43

(57) ABSTRACT

A method for allocation of an advertisement budget of an advertisement campaign between a plurality of advertisement entities. The method comprises receiving for each of the plurality of advertisement entities a corresponding optimal value of its target frontier function respective of an advertising cost; receiving at least a budget constraint for the advertisement budget; creating a global target frontier function that is a sum of each of the target frontier functions of each of the plurality of advertisement entities, each of the target frontier function is multiplied by a binary inclusion variable; and optimizing the global target frontier function to determine a marginal equilibrium to determine at least the advertising cost value for each of the advertisement entities, the sum of the advertising cost values determined for each of the plurality of advertisement entities meets the budget constraint.

### CROSS REFERENCE TO RELATED APPLICATIONS

This patent application claims the benefit of US Provisional Application No. 61/371,701 filed Aug. 8, 2010, and is hereby incorporated by reference for all that it contains.

### TECHNICAL FIELD

The invention generally relates to allocation of budgets for keywords, and more particularly to the determination of optimal use of an advertisement budget between a plurality of advertisement entities to ensure that the total budget is not exceeded.

### BACKGROUND OF THE INVENTION

The ubiquity of access availability to information using the Internet and the worldwide web (WWW), within a short period of time, and by means of a variety of access devices, has naturally drawn the focus of advertisers. The advertiser wishes to quickly and cost effectively reach the target audience and once reached, enable an effective conversion of the observer of an advertisement into a purchase of goods or services. The advertisers therefore pay search engines, such as Google® or Yahoo!®, for the placement of their advertisement when the keyword is presented by a user for a search. There are budgets allocated for the plurality of advertisement entities, such as keywords, advertisement channels, advertisement portfolios, and so on, relevant to the advertisement campaign and the campaign manager has to allocate them efficiently without exceeding the budget limit.

Prior art solutions disclose the use of efficient frontiers for the purpose of management of, for example, investment portfolios. Other solutions disclose an approach for budget constraints to solve dynamic multi-factor models in finance. However, despite the teaching of the prior art, no general solution is provided for the optimization of a constrained budget to be allocated between different advertisement entities, and particularly, none is provided for the web environment that may have a multitude of dynamically changing advertisement entities.

It would therefore be advantageous to provide a solution that would optimize the use of an advertisement budget between advertisement entities.

### SUMMARY OF THE INVENTION

Certain embodiments disclosed herein include a method for allocation of an advertisement budget of an advertisement campaign between a plurality of advertisement entities. The method comprises receiving for each of the plurality of advertisement entities a corresponding optimal value of its target frontier function respective of an advertising cost; receiving at least a budget constraint for the advertisement budget; creating a global target frontier function that is a sum of each of the target frontier functions of each of the plurality of advertisement entities, each of the target frontier function is multiplied by a binary inclusion variable; optimizing the global target frontier function to determine a marginal equilibrium, wherein determination of the marginal equilibrium results in an advertising cost value for each of the plurality of advertisement entities and a value of the binary inclusion variable for each of the target frontier functions, wherein a sum of the advertising cost values determined for each of the plurality of advertisement entities meets the budget constraint; and reporting the determined values.

Certain embodiments disclosed herein also include a computing system for allocation of an advertisement budget of an advertisement campaign between a plurality of advertisement entities. The system comprises an input/output interface for receiving for each of the plurality of advertisement entities a corresponding optimal value of its target frontier function respective of an advertising cost and at least a budget constraint for the advertisement budget; a data storage for storing at least the received data regarding the plurality of advertisement entities and the budget constraint; a processing unit for creating a global target frontier function that is a sum of each of the target frontier functions of each of the plurality of advertisement entities, each target frontier function is multiplied by a binary inclusion variable, wherein the processing unit further optimizes the global target frontier function to determine a marginal equilibrium, wherein determination of the marginal equilibrium results in an advertising cost value for each of the plurality of advertisement entities and a value of the binary inclusion variable for each of the target frontier functions, wherein a sum of the advertising cost values determined for each of the plurality of advertisement entities meets the budget constraint.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system for allocating an advertisement budget to a plurality of advertisement entities.

FIG. 2 is a flowchart describing the allocation of the advertisement budget to a plurality of advertisement entities in accordance with the principle of the invention.

FIG. 3 is a graph depicting optimal allocation of an advertisement budget according to a particular non-limiting example.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Campaign managers managing advertisement campaigns over the web allocate budgets daily between different advertisement entities such as keywords, advertisement channels, advertisement portfolios, and so on. For example, advertisement channels may include the web outlet for placing the advertisements, for example, search engine ads, websites displaying ads on their pages (e.g., as banners), or ads displayed over native applications executed by, for example, handled devices, such as smart phones and tablet computers. The advertisement's entity may be a combination of keywords and one or more advertisement channels. For example, the advertisement's entity may be using a set of keywords in Google's search engine. An advertisement portfolio is collection of advertisements having a similar classification (e.g., same client, same type, same topic, etc.).

Ensuring that an efficient allocation of the budget is reached that provides an optimal use of the budget at hand is advantageous. By managing the efficiency frontier of a campaign objective or a portfolio goal an optimum budget allocation between different entities may be maintained.

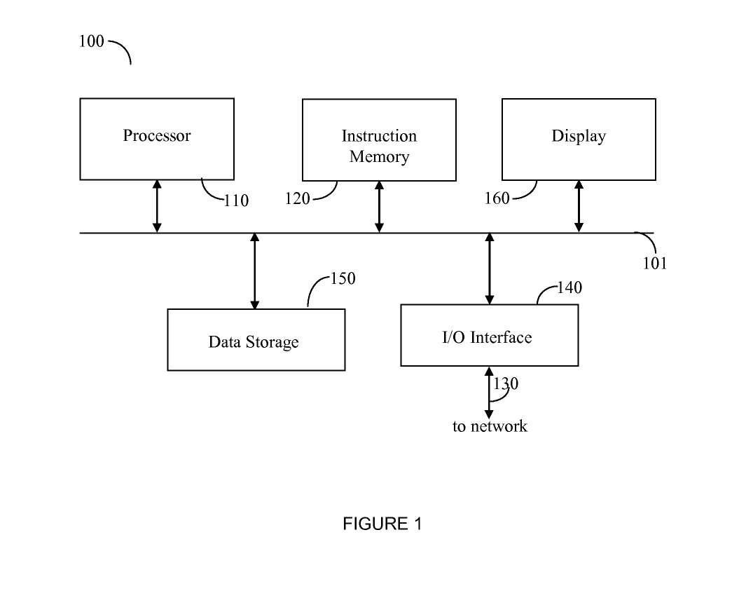

FIG. 1 depicts an exemplary and non-limiting schematic diagram of a system 100 for allocating an advertisement budget to a plurality of advertisement entities, also referred to herein as a ‘entity’ or ‘entities’ for short.

The system 100 comprises a processor 110 that is connected to an instruction memory 120 that contains, among others, a plurality of instructions that when executed by the processor 110 results in the finding of an optimal allocation of a constrained advertisement budget between a plurality of advertisement entities. The processor 110 is further connected to a data storage unit 150 that holds data regarding the advertisement entities, the constraints, and other relevant data. The processor 110 is further connected to an input/output (I/O) interface 140 that is connected to a network, through a connection 130, that allows the system 100 to access the advertisement entities and use the budget as may be applicable. A display 160 may be further connected to the processor 110 enabling a user to provide data, information and feedback regarding the process of the budget allocation process, and as further explained in greater detail below. The components of the system 100 communicate with each other through an interconnect bus 101.

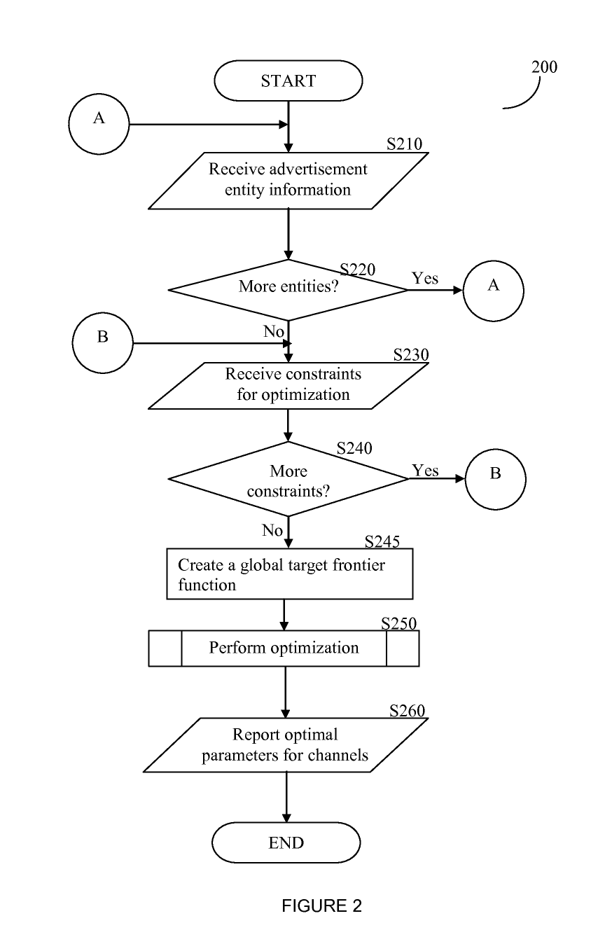

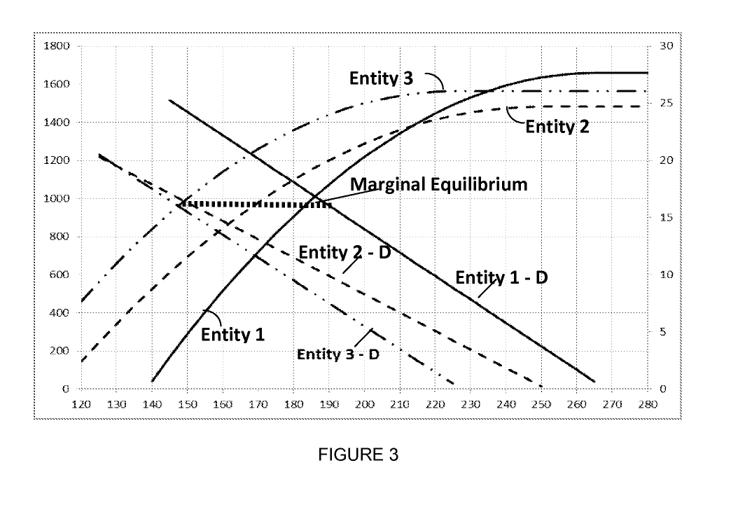

According to an embodiment of the invention, the display 160 can display results of the allocation process to a user, enabling the user to accept responses from the user regarding the allocation process, including, but not limited to, receiving answers to questions displayed. It should be understood though that the use of a display 160 is a mere example of a user interface that enables providing the user with information regarding the allocation process, and other user interfaces are specifically to be considered an integral part of this invention. Furthermore, in one embodiment of the invention, the display may include touch-screen mechanisms (not shown) to allow the user easy interaction with the system 100, which will be further understood with respect of FIGS. 2 and 3 discussed in more detail herein below.

FIG. 2 shows an exemplary and non-limiting flowchart 200 describing a method of allocation of the advertisement budget of an advertisement campaign to a plurality of advertisement entities in accordance with certain embodiments of the invention. In an embodiment of the invention, the method described herein can be performed by the system 100 illustrated in FIG. 1.

In S210, there is received information with respect of an advertisement entity from a user. Particularly the information includes an optimal target function of the advertisement entity. The information received is typically stored in memory, for example, the data storage unit 150 (FIG. 1). In exemplary embodiment of the invention, a user is a campaign manager managing the advertisement campaign.

In S220, it is checked whether another advertisement entity is to be added, and if so execution returns to S210; otherwise, execution continues with S230.This repeating process allows the user to easily add a large number of advertisement entities typically needed to be addressed by a user having an advertisement budget used for advertisement entities in the world-wide web (WWW) environment.

In one embodiment of the invention, the user only enters the name of the advertisement entity to be used and the system 100, using the I/O interface 140, accesses via the network information with respect of the optimal target function of that entity. Alternatively, such data may already reside in the data storage unit 150 and retrieved therefrom. In S230, there are provided constraints that are to be used in the process of optimization. The constraints may be for a single advertisement entity, or a collection of advertisement entities. Constraints typically include, but are not limited to, a budget constraint that limits the total budget that can be spent on all the entities together for a particular advertisement campaign. Other constraints may include a minimal return-on-investment (ROI) constraint, determined, for the optimization purposes as the ration between the total revenue divided by the total cost. In one embodiment the user provides this through an interactive process, however, it is possible that one or more of the constraints are provided by automatic means. For example, the system 100 may access a database containing budget information for the advertisement campaign and retrieve the budget constraint therefrom. The constraints will be typically stored in the data storage unit 150.

In S240 it is checked whether additional constraints are to be added, and if so execution continues with S230; otherwise, execution continues with S245. In S245 a global target frontier function is created. The global target frontier may be a profit function, revenue function, traffic volume function, or any other desired objective function that is optimized to meet the input constraints. Examples for global target frontier functions that can be utilized for the budget allocation for the advertisement campaign are provided below.

In S250, the global target frontier function is optimized on the plurality of advertisement entities with respect of the constraints. In an embodiment of the invention the global target frontier functions to determine a marginal equilibrium. There are multiple computation tools that can perform the optimization which are outside of the scope of the invention and are known to those of ordinary skill in the art. In S260, a report is provided with the specific optimal results that should be used for the particular case at hand. These results can then be used to allocate the budgets to each entity, the total of which should be within the defined constraints. The system 100 may them manage the advertisement campaign based on set constraints or allow the user to do so manually by displaying the selected optimal values and providing the appropriate value to each entity.

To further understand the operation of the system 100 and the method described above and prior to providing a particular and non-limiting example, a more general discussion is provided. For an entity ‘i’ an objective such as the profit function, revenue function, traffic volume function, or any other desired objective function, may be described as:

Sᵢ(xᵢ); (1)

Where, S is a target frontier function for an advertisement entity ‘i’; the value ‘i’ is an integer between 1 and n, denoting an advertisement entity index. The target frontier function is a frontier of the objective, i.e., the optimal value at a point xᵢ. The function S may be any kind of function, but typically it appears as increasing as the value of x increases up to a point where there is either stabilization or even a decrease in the profit S, following the law of diminishing return. According to an embodiment of the invention, the value xᵢ may represent the amount of money that is spent for an entity ‘i’ (hereinafter “advertising cost”) and the target frontier S may represent the optimal profit. In this case, the frontier is achieved by optimizing the profit internally for each entity.

The global target frontier function Z that may represent the overall profit when a plurality of functions are used may be described as:

Z(x)=ΣyᵢSᵢ(xᵢ); (2)

where, the value ‘i’ is an integer between 1 and n, denoting an advertisement entity index. In an embodiment of the invention, the value of ‘y’ is binary, i.e., it may be either ‘1’ or ‘0’ depending if the entity should or should not be participating in the budget allocation. The y, value may be either defined by a user or set by the optimization process. In addition, each advertising cost value ‘xᵢ’ for an entity ‘i’ may be further constrained, for example, within a range, to be at least a certain amount, or not to exceed an amount, and so on. If a budget allocation is defined then the sum of the values of ‘x’ may be further constrained by the budget allocation limitation. The solution provided by the optimization step provides advertising cost values ‘x’s to each entity involved in the campaign, and the particular profit Z is then also determined. The profit Z may be the total revenue from the advertisement campaign excess over the outlaid advertising costs. Alternatively, the profit may be the income of the advertising agency for managing the campaign excess over outlaid advertising costs.

Following is an exemplary and non-limiting example for allocation of the advertisement budget to three advertisement entities, each of which need to be allocated to a budget x₁, x₂, and x₃ respectively. The optimal target functions for each of the entities were therefore found to be the following:

S₁(x₁)=−0.1x₁²+54x₁−5533.4; (3)

S₂(x₂)=−0.08x₂²+40x₂−3500; and (4)

S₃(x₃)=−0.1x₃²+45x₃−3500. (5)

The optimizer will therefore attempt, in accordance with certain embodiments of the invention to maximize the following:

Z=y₁*(−0.1x₁²+54x₁−5533.4)+y₂*(−0.08x₂²+40x₂−3500)+y₃*(−0.1x₃²+45x₃−3500) (6)

which is the sum of the three individual optimal target functions. Constraints may be added, and in this case include the following exemplary and non-limiting constraints:

140≦x₁≦265, i.e., a range value for x₁; (7)

120≦x₂≦250, i.e., a range value for x₂; (8)

120≦x₃≦225, i.e., a range value for x₃; (9)

where lower and upper boundaries for x₁, x₂, and x₃ are found in the process of building the frontier functions, for example, the lower boundaries may be points above which the profit is positive, upper bounds may be the points where the graphs flatten out.

x₁+x₂+x₃≦500; (10)

That is, a budget upper limit that may not be reached or exceeded; and

y₁,y₂,y₃ε{0,1}; (11)

That is, all three entities may have a chance of receiving a portion of the budget.

It should be understood by those of ordinary skill in the art that more constraints can be added, such as but not limited to ROI constraints.

Running this using an optimizer yields the following results as an optimal solution:

x₁=193.1, i.e., spend 193.1 in a particular unit of currency on entity 1; (12)

x₂=156.4, i.e., spend 156.4 in a particular unit of currency on entity 2; and (13)

x₃=150.5, i.e., spend 150.5 in a particular unit of currency on entity 3. (14)

Obviously, in the solution of this case each of the ‘y’ values is ‘1’ as there is an ‘x’ value that is greater than 0 for each of the entities. However, it is possible that certain entities are found to be not appropriate to participate in the optimization process or otherwise be allocated a value of 0 even if they potentially could participate. The sum of the ‘x’ values is 500 which complies with the budget constraint. The total profit in this case amounts to 2,917.6 in the chosen currency (computed from the function Z of equation (6) defined above).

FIG. 3 shows a graph of the three optimal target functions, their respective first derivative and the marginal equilibrium that determines the results shown above. The graphs marked ‘Entity 1’, ‘Entity 2’ and ‘Entity 3’ are shown in different types of lines and correspond respectively to the equations (3), (4) and (5) defined above.

As part of the optimization process a first derivative of each of equations (3), (4) and (5) is made, each such derivative is shown as Entity 1-D, Entity 2-D, and Entity 3-D respectively. The dotted line marked ‘Marginal Equilibrium’ shows the optimal solution for the given equations and corresponding constraints. That dotted line could ‘float’ within the derivative lines to an extent based on the constraints (7), (8) and (9). However, the budget constraint (10) provides the optimal solution in this case. The horizontal axis provides the value for the xᵢ, the left vertical axis for the profit units, and the right vertical axis donates values for the marginal contribution, representing the derivative, basically a declining contribution as the amount invested increases.

The various embodiments discussed hereinabove may be applied in other applications without departing from the spiriting of the invention. For example, and without limitations, it may be applied towards dividing a common budget among a plurality of groups or categories of keywords within the same portfolio, such as in the case of encountering a scalability problem when dealing with many millions of keywords. The result is the optimization of each separate smaller group under its own budget constraints.

The principles of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for allocation of an advertisement budget of an advertisement campaign between a plurality of advertisement entities, comprising:
receiving for each of the plurality of advertisement entities a corresponding optimal value of its target frontier function respective of an advertising cost;
receiving at least a budget constraint for the advertisement budget;
creating a global target frontier function that is a sum of each of the target frontier functions of each of the plurality of advertisement entities, each of the target frontier function is multiplied by a binary inclusion variable;
optimizing the global target frontier function to determine a marginal equilibrium, wherein determination of the marginal equilibrium results in an advertising cost value for each of the plurality of advertisement entities and a value of the binary inclusion variable for each of the target frontier functions, wherein a sum of the advertising cost values determined for each of the plurality of advertisement entities meets the budget constraint; and
reporting the determined values.

2. The method of claim 1, wherein the global target frontier function represents the overall profit of the advertisement campaign, thereby optimizing the total profit of the advertisement campaign.

3. The method of claim 1, wherein if a value of a binary inclusion variable is determined to be zero, a corresponding advertisement entity is not included in the advertisement campaign, thereby optimizing the global target frontier function results in an optimal set of advertisement entities to be participated in the advertisement campaign while meeting the budget constraints.

4. The method of claim 1, wherein the determined advertising cost value is the amount of money that is spent for a respective advertisement entity.

5. The method of claim 1, wherein an advertisement entity is at least one of: a keyword, an advertisement channel, an advertisement portfolio.

6. The method of claim 1, further comprising:
receiving additional constraints.

7. The method of claim 6, wherein the additional constraints are at least one of:
return on investment (ROI), range of advertisement budget, range of advertising cost per advertisement entity, minimal advertisement budget , minimal advertising cost per advertisement entity, maximum cost, maximum advertising cost on a per advertisement entity.

8. The method of claim 1, wherein the at least budget constraint is extracted from a database.

9. The method of claim 1, wherein an optimal value of a target frontier function for at least one advertisement entity is received responsive of probing an information resource on the world-wide web (WWW).

10. The method of claim 1, wherein reporting the determined values comprises a display of the optimized values on a display.

11. The method of claim 1, wherein at least one target function is received through a user interface.

12. The method of claim 1, wherein at least one constraint is received through a user interface.

13. A computing system for allocation of an advertisement budget of an advertisement campaign between a plurality of advertisement entities, comprising:
an input/output interface for receiving for each of the plurality of advertisement entities a corresponding optimal value of its target frontier function respective of an advertising cost and at least a budget constraint for the advertisement budget;
a data storage for storing at least the received data regarding the plurality of advertisement entities and the budget constraint;
a processing unit for creating a global target frontier function that is a sum of each of the target frontier functions of each of the plurality of advertisement entities, each target frontier function is multiplied by a binary inclusion variable, wherein the processing unit further optimizes the global target frontier function to determine a marginal equilibrium, wherein determination of the marginal equilibrium results in an advertising cost value for each of the plurality of advertisement entities and a value of the binary inclusion variable for each of the target frontier functions, wherein a sum of the advertising cost values determined for each of the plurality of advertisement entities meets the budget constraint.

14. The computing system of claim 13, further comprising:
a display unit for displaying the determined values in a form of at least one of tabulated data and a graph.

15. The system of claim 13, wherein the global target frontier function represents the overall profit of the advertisement campaign, thereby optimizing the total profit of the advertisement campaign.

16. The system of claim 13, wherein if a value of a binary inclusion variable is determined to be zero, a corresponding advertisement entity is not included in the advertisement campaign, thereby optimizing the global target frontier function results in an optimal set of advertisement entities to be participated in the advertisement campaign while meeting the budget constraints.

17. The system of claim 13, wherein the determined advertising cost value is the amount of money that is spent for a respective advertisement entity.

18. The system of claim 13, wherein an advertisement entity is at least one of: a keyword, an advertisement channel, an advertisement portfolio.

19. The system of claim 13, wherein an optimal value of a target frontier function for at least one advertisement entity is received responsive of probing an information resource on the world-wide web (WWW).

20. A computer software product containing a plurality of instructions embedded in a tangible and non-transient computer readable medium that when executed by a computing device causing for allocation of an advertisement budget of an advertisement campaign between a plurality of advertisement, comprising:
receiving for each of the plurality of advertisement entities a corresponding optimal value of its frontier target function respective of an advertising cost;
receiving at least a budget constraint for the advertisement budget;
creating a global target frontier function that is a sum of each of the target frontier functions of each of the plurality of advertisement entities, each target frontier function is multiplied by a binary inclusion variable;
optimizing the global target frontier function to determine a marginal equilibrium, wherein determination of the marginal equilibrium results in an advertising cost value for each of the plurality of advertisement entities and a value of the binary inclusion variable for each of the target frontier functions, wherein a sum of the advertising cost values determined for each of the plurality of advertisement entities meets the budget constraint
reporting the determined values.
